(19) United States
(12) Patent Application Publication
(10) Pub. No.: US 2024/0327261 A1
(43) Pub. Date: Oct. 3, 2024

(54) WATER TREATMENT SYSTEM

(71) Applicant: HifilM INC., Yongin-si (KR)

(72) Inventors: Hee-Wan MOON, Yongin-si (KR); Yong-Cheol SHIN, Yongin-si (KR); Ho-Chan JUNG, Yongin-si (KR); Chul Woong JANG, Gimpo-si (KR); Kwang Ho CHOO, Daegu (KR); Pyung-Kyu PARK, Wonju-si (KR); Hyun-Suk OH, Seoul (KR); Kibaek LEE, Gwangju (KR); Jaewoo LEE, Daejeon (KR)

(73) Assignee: HifilM INC., Yongin-si (KR)

(21) Appl. No.: 18/395,897

(22) Filed: Dec. 26, 2023

(30) Foreign Application Priority Data
Mar. 31, 2023 (KR) 10-2023-0042634

(51) Int. Cl. C02F 3/28

(52) U.S. Cl. CPC C02F 3/2853; C02F 2201/002

(57) ABSTRACT

Disclosed is a water treatment system capable of inhibiting the occurrence of membrane fouling during water treatment at a relatively low cost without reducing water permeability of a filtration membrane. The water treatment system includes a biological treatment unit for biological treatment of wastewater and a membrane unit for filtration of the wastewater treated by the biological treatment unit, wherein at least one selected from the group consisting of the biological treatment unit and the membrane unit includes a plurality of quorum quenching media confined in a predetermined space therein.

### CROSS REFERENCE TO RELATED APPLICATIONS

This application claims priority based on Korean Patent Application No. 10-2023-0042634 filed Mar. 31, 2023, of which the entire content is incorporated by reference herein.

### BACKGROUND

### Technical Field

The present disclosure relates to a water treatment system, and more particularly to a water treatment system capable of inhibiting the occurrence of membrane fouling during water treatment at a relatively low cost without reducing water permeability of a filtration membrane.

### Description of the Related Art

A membrane bioreactor system (hereinafter referred to as an “MBR system”) is a water treatment system that combines a biological treatment process with a membrane separation process in order to remove contaminants from wastewater.

In general, the MBR system may include a flow control tank, an anoxic tank, an anaerobic tank, an aerobic tank, and a membrane tank. In the anoxic tank, the anaerobic tank, and the aerobic tank, the wastewater is biologically treated (i.e. contaminants, such as organic material, nitrogen, and phosphorus, are removed by microbes). In the membrane tank, filtration for solid-liquid separation is performed.

While the filtration is performed in the membrane tank, microbes present in wastewater adhere to and grow on the surface of a filtration membrane to form a biofilm, whereby membrane fouling occurs. Such membrane fouling deteriorates separation performance and filtration efficiency of the filtration membrane and increases energy consumption.

Microbes release a specific signaling substance in response to the changes in various environmental conditions such as temperature, pH, and nutriment. When the density of microbes increases and the concentration of the signaling substance reaches a certain level, the microbes exhibit a collective behavior such as biofilm formation. When microbes recognize that the concentration of the signaling substance has reached a certain level, it is called “quorum sensing”.

Korean Patent Application Publication No. 10-2013-0034935 (hereinafter referred to as “Prior Art 1”), which is incorporated herein by reference, proposes a method of fixing quorum quenching microbes capable of producing an enzyme capable of decomposing the signaling substance used for quorum sensing on a carrier and then introducing the carrier into wastewater of the membrane tank. Prior Art 1 describes that (i) the quorum quenching microbes fixed on the carrier can molecular-biologically inhibit the biofilm formation and (ii) the carrier having fluidity thanks to the underwater aeration in the membrane tank can induce the separation of any existing biofilm from the filtration membrane by directly striking the surface of the membrane.

In most MBR systems, however, although a portion (e.g. ⅔) of the wastewater in the membrane tank is returned to the anoxic tank or the anaerobic tank as a return activated sludge (RAS), the remainder (e.g. ⅓) thereof is discharged from the membrane tank as a waste activated sludge (WAS) or a surplus activated sludge (SAS) and is thus removed from the MBR system. As a result, in Prior Art 1, in which the carriers having the quorum quenching microbes fixed thereon are fluidizably dispersed in the wastewater of the membrane tank, the carriers cannot but be continuously lost along with the waste activated sludge (WAS) or the surplus activated sludge (SAS). Thus, in order to maintain the membrane fouling-preventing effect during the operation of the MBR system, the carriers having microbes fixed thereon must be continuously supplied to the membrane tank, which seriously reduces the economic feasibility of the MBR system.

Meanwhile, Korean Patent Application Publication No. 10-2022-0161764 (hereinafter referred to as “Prior Art 2”), which is also incorporated herein by reference, proposes to attach the quorum quenching microbes to the filtration membrane itself via a hydrophilic polymer.

However, the filtration membrane of Prior Art 2 cannot but show a relatively low water permeability because the quorum quenching microbes attached thereto may act as a kind of contaminant. Prior Art 2 itself also acknowledges this problem.

### BRIEF SUMMARY

Therefore, the present disclosure relates to a water treatment system capable of preventing problems resulting from limitations and shortcomings of the related art described above.

It is an object of the present disclosure to provide a water treatment system capable of inhibiting the occurrence of membrane fouling during water treatment at a relatively low cost without reducing water permeability of a filtration membrane.

In addition to the above object, other features and advantages of the present disclosure will be described hereinafter, or will be clearly understood by those skilled in the art to which the present disclosure pertains from the following description thereof.

In accordance with an aspect of the present disclosure, the above and other objects can be accomplished by the provision of a water treatment system including a biological treatment unit for biological treatment of wastewater and a membrane unit for filtration of the wastewater treated by the biological treatment unit, wherein at least one selected from the group consisting of the biological treatment unit and the membrane unit includes a plurality of quorum quenching media confined in a predetermined space therein.

The plurality of quorum quenching media may be confined in the predetermined space by means of a mesh-shaped container.

Each of the quorum quenching media may include a carrier and quorum quenching microbes on the carrier.

The carrier may be a hydrogel of a three-dimensional reticulated structure including at least one selected from the group consisting of alginate, polyvinyl alcohol, polyethylene glycol, and polyurethane.

The membrane unit may include a tank into which the wastewater treated by the biological treatment unit is introduced and at least one membrane filtration apparatus configured to perform filtration in the state in which at least a part of the membrane filtration apparatus is submerged in the wastewater introduced into the tank.

The membrane unit may further include a mesh-shaped container mounted on the tank such that at least a part of the mesh-shaped container is submerged in the wastewater, at least a portion of the quorum quenching media may be disposed in the mesh-shaped container, and the quorum quenching media may have a particle size greater than a pore size of the mesh-shaped container.

The membrane filtration apparatus may include a skid frame, a plurality of membrane modules installed in the skid frame, and at least one quorum quenching module installed in the skid frame, the quorum quenching module may include upper and lower headers detachably coupled to the skid frame and a mesh-shaped container disposed between the upper and lower headers, both ends of the mesh-shaped container being coupled to the upper and lower headers, respectively, at least a portion of the quorum quenching media may be disposed in the mesh-shaped container, and the quorum quenching media may have a particle size greater than a pore size of the mesh-shaped container.

The membrane unit may further include a driving unit for reciprocating motion of the membrane filtration apparatus.

The membrane unit may further include a first rail configured to reciprocate together with the membrane filtration apparatus, a second rail configured to guide the reciprocating motion of the membrane filtration apparatus, and a free-roller located between the first and second rails, the free-roller being movable relative to both the first and second rails.

The membrane unit may include a plurality of the membrane filtration apparatuses, the membrane unit may further include a reciprocating frame to which the plurality of membrane filtration apparatuses are individually coupled, the driving unit may be configured to implement the reciprocating motion of the membrane filtration apparatuses through the reciprocating frame, the reciprocating frame may have a bottom surface that faces the free-roller, and the first rail may be mounted on the bottom surface of the reciprocating frame.

The first rail may be elastically mounted on the bottom surface of the reciprocating frame such that the distance between the first rail and the reciprocating frame is variable.

The membrane unit may further include a guide frame provided on the top of the tank, the guide frame may have a top surface that faces the free-roller, and the second rail may be mounted on the top surface of the guide frame.

The membrane unit may further include a pivot member having a central hole, a first end of the pivot member may be pivotably coupled to the guide frame, a second end of the pivot member may be a two-pronged end having first and second fingers, a rotating shaft connected to a rotation axis of the free-roller may extend through the central hole of the pivot member, and a protrusion provided at the reciprocating frame may be disposed in a gap between the first and second fingers.

The membrane unit may include a plurality of the membrane filtration apparatuses, each of the membrane filtration apparatuses may include a skid frame and a plurality of membrane modules installed in the skid frame, the skid frame may include a supporting frame, a lower horizontal frame, an upper horizontal frame located between the supporting frame and the lower horizontal frame, and a plurality of vertical members configured to connect the supporting frame, the upper horizontal frame, and the lower horizontal frame to each other, the supporting frame may have a bottom surface that faces the free-roller, and the first rail may be mounted on the bottom surface of the supporting frame.

The first rail may be elastically mounted on the bottom surface of the supporting frame such that the distance between the first rail and the supporting frame is variable.

The membrane unit may further include a guide frame provided on the top of the tank, the guide frame may have a top surface that faces the free-roller, and the second rail may be mounted on the top surface of the guide frame.

The membrane unit may further include a pivot member having a central hole, a first end of the pivot member may be pivotably coupled to the guide frame, a second end of the pivot member may be a two-pronged end having first and second fingers, a rotating shaft connected to a rotation axis of the free-roller may extend through the central hole of the pivot member, and a protrusion provided at the supporting frame may be disposed in a gap between the first and second fingers.

The supporting frames of the plurality of membrane filtration apparatuses may be detachably coupled to each other, and each of the membrane filtration apparatuses may further include a lifting hook receiver provided on the supporting frame.

The biological treatment unit may include at least one selected from the group consisting of an anoxic tank, an anaerobic tank, and an aerobic tank.

The biological treatment unit may include the aerobic tank, and at least a portion of the quorum quenching media may be confined in a predetermined space in the aerobic tank.

The biological treatment unit may include the anoxic tank or the anaerobic tank, and at least a portion of the quorum quenching media may be confined in a predetermined space in the anoxic or anaerobic tank.

The water treatment system may further include a flow control unit configured to control the flow of wastewater to be supplied to the biological treatment unit.

The general description of the present disclosure given above is provided merely to illustrate or describe the present disclosure, and does not limit the scope of rights of the present disclosure.

### BRIEF DESCRIPTION OF THE SEVERAL VIEWS OF THE DRAWINGS

The accompanying drawings, which are included to assist in understanding of the present disclosure and are incorporated in and constitute a part of the present specification, illustrate embodiments of the present disclosure and serve to explain the principle of the present disclosure together with the detailed description of the present disclosure.

FIGS. 1(a) to 1(c) are views schematically showing water treatment systems according to first to third embodiments of the present disclosure, respectively;

FIG. 2 is an exploded perspective view schematically showing a membrane filtration apparatus of a water treatment system according to another embodiment of the present disclosure;

FIG. 3 is an exploded perspective view schematically showing a membrane unit according to an embodiment of the present disclosure;

FIG. 4 is an exploded perspective view schematically showing a membrane filtration apparatus of the membrane unit;

FIGS. 5(a) and 5(b) are a perspective view and a sectional view, respectively, schematically showing a guide mechanism of the membrane unit;

FIG. 6 is an exploded perspective view schematically showing a double-deck type filtration apparatus according to another embodiment of the present disclosure;

FIGS. 7(a) and 7(b) are sectional views schematically showing a guide mechanism according to another embodiment of the present disclosure;

FIGS. 8(a), 8(b), and 8(c) are a perspective view, a sectional view, and a front view, respectively, schematically showing a guide mechanism according to a further embodiment of the present disclosure;

FIG. 9 is a perspective view schematically showing a membrane unit according to another embodiment of the present disclosure;

FIG. 10 is an exploded perspective view schematically showing a membrane filtration apparatus of the membrane unit;

FIGS. 11(a) and 11(b) are a perspective view and a sectional view, respectively, schematically showing a guide mechanism of the membrane unit;

FIGS. 12(a) and 12(b) are sectional views schematically showing a guide mechanism according to another embodiment of the present disclosure; and

FIGS. 13(a), 13(b), and 13(c) are a perspective view, a sectional view, and a front view, respectively, schematically showing a guide mechanism according to a further embodiment of the present disclosure.

### DETAILED DESCRIPTION OF THE DISCLOSURE

Hereinafter, various embodiments of the present disclosure will be described in detail with reference to the accompanying drawings.

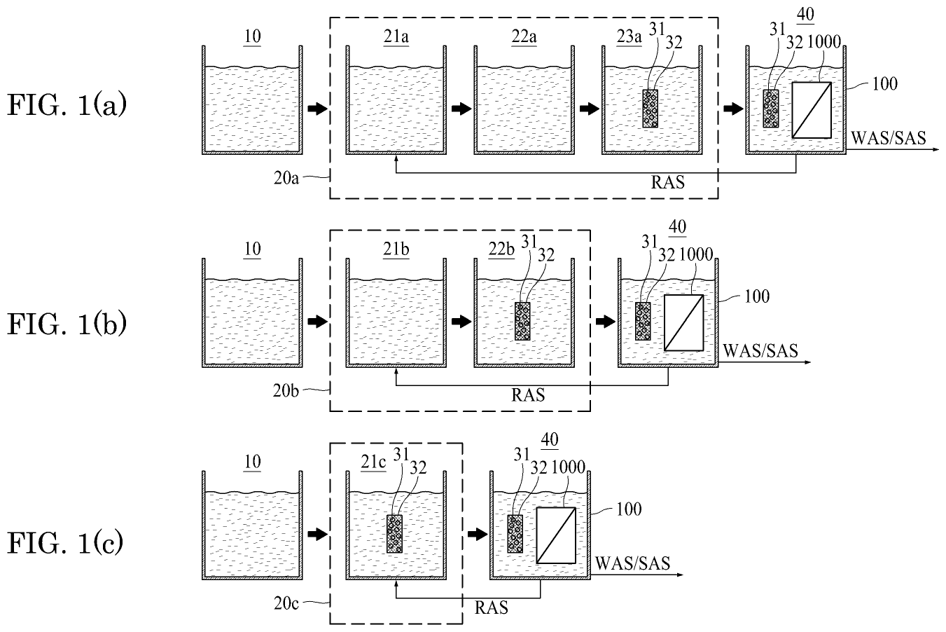

FIGS. 1(a) to 1(c) are views schematically showing water treatment systems according to first to third embodiments of the present disclosure, respectively. As illustrated in FIGS. 1(a) to 1(c), the water treatment system according to the present disclosure includes a biological treatment unit 20a, 20b, or 20c for biological treatment of wastewater and a membrane unit 40 for filtration of the wastewater treated by the biological treatment unit 20a, 20b, or 20c.

The biological treatment unit 20a, 20b, or 20c may include at least one selected from the group consisting of an anoxic tank, an anaerobic tank, and an aerobic tank. That is, the biological treatment unit 20a, 20b, or 20c of the present disclosure may have different configurations depending on the type of wastewater to be treated (i.e. the type of main contaminants).

For example, as illustrated in FIG. 1(a), the biological treatment unit 20a of the water treatment system according to the first embodiment of the present disclosure includes a first tank 21a, a second tank 22a, and a third tank 23a. The first tank 21a may be an anoxic tank in which nitrous acid and/or nitric acid is reduced to nitrogen gas by denitrifying microbes and thus removed, the second tank 22a may be an anaerobic tank in which phosphorus release reaction by anaerobic microbes takes place, and the third tank 23a may be an aerobic tank in which organic material is decomposed to carbon dioxide and water by aerobic microbes and ammoniacal nitrogen is nitrified to nitrous acid or nitric acid by nitrifying microbes. Depending on circumstances, the order of the anoxic tank and the anaerobic tank may be reversed.

Alternatively, as illustrated in FIG. 1(b), the biological treatment unit 20b of the water treatment system according to the second embodiment of the present disclosure includes a first tank 21b and a second tank 22b, wherein the first tank 21b may be an anoxic tank and the second tank 22b may be an anaerobic tank or an aerobic tank.

As illustrated in FIG. 1(c), the biological treatment unit 20c of the water treatment system according to the third embodiment of the present disclosure includes only one tank 21c, which may be an anoxic tank, an anaerobic tank, or an aerobic tank.

As illustrated in each of FIGS. 1(a) to 1(c), the water treatment system according to the present disclosure may further include, as an optional element, a flow control unit 10. The flow control unit 10 may control the flow of wastewater to be supplied to the biological treatment unit 20a, 20b, or 20c and may equalize water quality thereof.

Wastewater supplied from the flow control unit 10 is biologically treated when passing through the biological treatment unit 20a, 20b, or 20c and is then introduced into the membrane unit 40. In the membrane unit 40, solid-liquid separation (i.e. filtration) is performed on the wastewater treated by the biological treatment unit 20a, 20b, or 20c.

A portion of the wastewater introduced into the membrane unit 40 is returned to the tank 21a, 21b, or 21c of the biological treatment unit 20a, 20b, or 20c as a return activated sludge (RAS), whereas the remainder thereof is discharged from the membrane unit 40 as a waste activated sludge (WAS) or a surplus activated sludge (SAS) and is thus removed from the water treatment system.

According to the present disclosure, at least one selected from the group consisting of the biological treatment unit 20a, 20b, or 20c and the membrane unit 40 includes a plurality of quorum quenching media 31 confined in a predetermined space therein. That is, although a water treatment system in which both the biological treatment unit 20a, 20b, or 20c and the membrane unit 40 include the quorum quenching media 31 is illustrated in FIGS. 1(a) to 1(c), respectively, only one thereof may include the quorum quenching media 31.

The expression “confined in a predetermined space” as used herein means that the quorum quenching media can move only in the predetermined space and cannot escape therefrom, during the water treatment operation.

As schematically illustrated in FIGS. 1(a) to 1(c), the membrane unit 40 of the present disclosure includes a tank 100 into which the wastewater treated by the biological treatment unit 20a, 20b, or 20c is introduced and at least one membrane filtration apparatus 1000 configured to perform filtration in the state in which at least a part thereof is submerged in the wastewater introduced into the tank 100. In addition, as described above, the membrane unit 40 of the present disclosure may include a plurality of quorum quenching media 31 confined in a predetermined space in the tank 100. Each of the quorum quenching media 31 may include a carrier and quorum quenching microbes on the carrier.

The carrier on which the quorum quenching microbes are fixed may be a hydrogel of a three-dimensional reticulated structure including at least one selected from the group consisting of alginate (e.g. sodium alginate), polyvinyl alcohol, polyethylene glycol, and polyurethane.

The quorum quenching microbes are microbes capable of producing an enzyme (e.g. lactonase, acylase, etc.) capable of decomposing a signaling substance (N-acyl homoserine lactones: AHL) used for quorum sensing. For example, Rhodococcus sp. BH4, Pseudomonas sp. KS2, Pseudomonas sp. 1A1, Pseudomonas sp. KS10, Bacillus sp. SDC-U1, etc. may be used as the quorum quenching microbes of the present disclosure.

The results of testing quorum sensing activity of the quorum quenching microbes showed a tendency among them to more rapidly decompose AHL having a longer carbon group (e.g. C8, C10, or 3-oxo-C12). It was shown that, however, Pseudomonas sp. 1A1 and Pseudomonas sp. KS10 are unable to decompose AHL having a short carbon group (e.g. C4, C6, or 3-oxo-C6). Therefore, it is preferable to use Rhodococcus sp. BH4, Pseudomonas sp. KS2, and Bacillus sp. SDC-U1 as the quorum quenching microbes, and it is more preferable to use Rhodococcus sp. BH4 which decomposed the AHL having a short carbon group most rapidly.

For example, the quorum quenching media 31 may be manufactured using a method including a step of multiplying the quorum quenching microbes by shaking culture, a step of obtaining a microbial aggregate by centrifuging the shaking culture solution and then removing the supernatant (i.e. a culture media) therefrom, a step of obtaining a microbial suspension by washing the microbial aggregate with a buffer solution and then suspending the same in ultrapure water, a step of mixing the microbial suspension with a carrier polymer solution (e.g. an alginate solution) to obtain a mixture solution, a step of spraying the mixture solution to a calcium chloride solution in order to induce crosslinking reaction, and a step of drying a hydrogel of a reticulated structure obtained through the crosslinking reaction.

The method of manufacturing the quorum quenching media 31 is disclosed in detail in Prior Art 1, which is incorporated herein by reference.

Thanks to the quorum quenching media 31 of the membrane unit 40, it is possible to prevent biofilm formation and resulting membrane fouling, which otherwise might be caused due to quorum sensing of microbes.

As schematically illustrated in FIGS. 1(a) to 1(c), the membrane unit 40 according to the embodiment of the present disclosure may further include a mesh-shaped container 32 which is mounted on the tank 100 in such a way that at least a part thereof is submerged in the wastewater. At least a portion of the quorum quenching media 31 may be disposed in the mesh-shaped container 32. The quorum quenching media 31 may have a particle size greater than the pore size of the mesh-shaped container 32 so as to be confined in the mesh-shaped container 32. That is, at least a portion of the plurality of quorum quenching media 31 may be confined in the predetermined space in the membrane unit 40 by means of the mesh-shaped container 32.

The mesh-shaped container 32 may be mounted on the tank 100, for example, via a support (not shown). For example, the support may be detachably fixed to an upper part of the tank 100 with a coupling means, such as a bolt, and the mesh-shaped container 32 may be suspended from the support such that at least a part thereof is submerged in the wastewater in the tank 100. Introduction and exchange of the quorum quenching media 31 may be easily achieved by separating the support from the tank 100 and taking the same out of the tank 100 together with the mesh-shaped container 32.

Since a signaling substance used for quorum sensing is also released from the microbes in the biological treatment unit 20a, 20b, or 20c, the signaling substance may be introduced into the membrane unit 40 when the wastewater biologically treated by the biological treatment unit 20a, 20b, or 20c is introduced into the membrane unit 40. Such inflow of the signaling substance may undermine the quorum quenching effect in the membrane unit 40.

Consequently, as described above, in addition to or instead of the membrane unit 40, the biological treatment unit 20a, 20b, or 20c may include a plurality of quorum quenching media 31 confined in a predetermined space therein.

In particular, when the wastewater stays in the membrane unit 40 for relatively short time and thus the amount of a signaling substance newly generated in the membrane unit 40 is much less than the amount of a signaling substance introduced into the membrane unit 40 from the biological treatment unit 20a, 20b, or 20c, the quorum quenching media 31 may be included only in the biological treatment unit 20a, 20b, or 20c. The quorum quenching media 31 may decompose the signaling substance released from microbes in the biological treatment unit 20a, 20b, or 20c, thereby preventing or minimizing the inflow of the signaling substance into the membrane unit 40.

Similarly to the quorum quenching media 31 of the membrane unit 40, the quorum quenching media 31 of the biological treatment unit 20a, 20b, or 20c may also be disposed in the mesh-shaped container 32 and may also have a particle size greater than the pore size of the mesh-shaped container 32 so as to be confined therein (i.e. in the predetermined space inside the biological treatment unit 20a, 20b, or 20c).

Although FIG. 1(a) illustrates the biological treatment unit 20a in which only the third tank 23a (i.e. the aerobic tank), among the first to third tanks 21a, 22a, and 23a, includes the quorum quenching media 31 therein, the present disclosure is not limited thereto. In order to achieve the object of preventing or minimizing the inflow of the signaling substance into the membrane unit 40, the first and/or second tanks 21a and/or 22a (i.e. the anoxic tank and/or the anaerobic tank) may also include the quorum quenching media therein.

Similarly, FIG. 1(b) illustrates the biological treatment unit 20b in which only the second tank 22b (i.e. the anaerobic tank or the aerobic tank), among the first and second tanks 21b and 22b, includes the quorum quenching media 31 therein. In order to achieve the object of preventing or minimizing the inflow of the signaling substance into the membrane unit 40, however, the first tank 21b (i.e. the anoxic tank) may also include the quorum quenching media therein.

In summary, the biological treatment unit 20a, 20b, or 20c may include an aerobic tank, and at least a portion of the quorum quenching media 31 may be confined in a predetermined space inside the aerobic tank by means of the mesh-shaped container 32. Alternatively or additionally, the biological treatment unit 20a, 20b, or 20c may include an anoxic tank and/or an anaerobic tank, and at least a portion of the quorum quenching media 31 may be confined in a predetermined space inside the anoxic tank and/or the anaerobic tank by means of the mesh-shaped container 32.

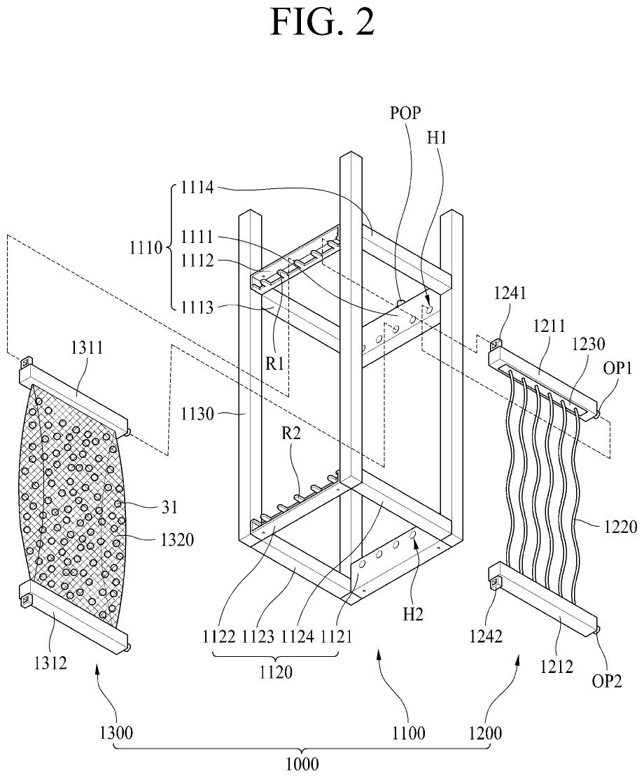

FIG. 2 illustrates an alternative embodiment for confining the quorum quenching media 31 in the predetermined space inside the membrane unit 40. As illustrated in FIG. 2, at least a portion of the quorum quenching media 31 of the membrane unit 40 may be incorporated into the membrane filtration apparatus 1000.

More specifically, the membrane filtration apparatus 1000 of this embodiment may include a skid frame 1100, a plurality of membrane modules 1200 installed in the skid frame 1100, and at least one quorum quenching module 1300 installed in the skid frame.

The skid frame 1100 may include an upper horizontal frame 1110, a lower horizontal frame 1120, and a plurality of vertical members 1130 configured to connect the upper horizontal frame 1110 and the lower horizontal frame 1120 to each other.

Although not shown, in order to increase mechanical durability, the skid frame 1100 may further include a plurality of reinforcing rods configured to connect the vertical members 1130 and the upper and lower horizontal frames 1110 and 1120 to each other in various ways.

Each of the membrane modules 1200 may include an upper header 1211 having a first outlet port OP1 at one end thereof, a lower header 1212 having a second outlet port OP2 at one end thereof, and a filtration membrane 1220 configured to fluidly communicate with the upper header 1211 and the lower header 1212.

One end and the other end of the filtration membrane 1220 are fixed respectively to the upper header 1211 and the lower header 1212 via potting layers 1230. The filtration membrane 1220 fluidly communicates with the upper header 1211 and the lower header 1212, whereby the permeate passing through the filtration membrane 1220 is introduced into water-collecting spaces of the upper header 1211 and the lower header 1212. Subsequently, the permeate is discharged from the membrane module 1200 through the first outlet port OP1 of the upper header 1211 and the second outlet port OP2 of the lower header 1212.

Although a hollow fiber membrane having a longitudinal direction parallel to the vertical members 1130 is illustrated as the filtration membrane 1220 in FIG. 2, the filtration membrane 1220 of the present disclosure is not limited thereto, and may be a flat sheet membrane.

The upper header 1211 and the lower header 1212 are coupled to the upper horizontal frame 1110 and the lower horizontal frame 1120, respectively, whereby the membrane module 1200 is installed in the skid frame 1100.

Specifically, the upper horizontal frame 1110 may include an upper cross pipe 1111 to which one end of the upper header 1211 is coupled via the first outlet port OP1, an upper cross bar 1112 to which the other end of the upper header 1211 is coupled, a first upper horizontal member 1113 configured to connect one end of the upper cross pipe 1111 and one end of the upper cross bar 1112 to each other, and a second upper horizontal member 1114 configured to connect the other end of the upper cross pipe 1111 and the other end of the upper cross bar 1112 to each other. The first outlet port OP1 of the upper header 1211 is inserted into a first hole H1 of the upper cross pipe 1111, whereby the one end of the upper header 1211 is coupled to the upper cross pipe 1111. The permeate discharged from the upper header 1211 through the first outlet port OP1 is introduced into the upper cross pipe 1111 and then flows out through a permeate outlet port POP.

Similarly, the lower horizontal frame 1120 may include a lower cross pipe 1121 to which one end of the lower header 1212 is coupled via the second outlet port OP2, a lower cross bar 1122 to which the other end of the lower header 1212 is coupled, a first lower horizontal member 1123 configured to connect one end of the lower cross pipe 1121 and one end of the lower cross bar 1122 to each other, and a second lower horizontal member 1124 configured to connect the other end of the lower cross pipe 1121 and the other end of the lower cross bar 1122 to each other. The second outlet port OP2 of the lower header 1212 is inserted into a second hole H2 of the lower cross pipe 1121, whereby the one end of the lower header 1212 is coupled to the lower cross pipe 1121. Permeate discharged from the lower header 1212 through the second outlet port OP2 is introduced into the lower cross pipe 1121.

At least one of the vertical members 1130, which connect the upper cross pipe 1111 and the lower cross pipe 1121 to each other, may have a pipe shape that fluidly communicates therewith, whereby the permeate introduced into the lower cross pipe 1121 may flow into the upper cross pipe 1111 and then be discharged to the outside through the permeate outlet port POP.

Alternatively, a separate permeate outlet port may be provided at the lower cross pipe 1121 such that the permeate introduced into the lower cross pipe 1121 is discharged to the outside therethrough.

The other end of the upper header 1211 is coupled to the upper cross bar 1112. For example, as illustrated in FIG. 2, a first rib R1 provided at the upper cross bar 1112 may be inserted into a first receiving member 1241 provided at the other end of the upper header 1211, whereby the other end of the upper header 1211 is coupled to the upper cross bar 1112.

Similarly, a second rib R2 provided at the lower cross bar 1122 may be inserted into a second receiving member 1242 provided at the other end of the lower header 1212, whereby the other end of the lower header 1212 is coupled to the lower cross bar 1122.

As schematically illustrated in FIG. 2, the at least one quorum quenching module 1300 may include an upper header 1311, a lower header 1312, and a mesh-shaped container 1320 disposed between the upper and lower headers 1311 and 1312, both ends of the mesh-shaped container being coupled to the upper and lower headers 1311 and 1312, respectively, and at least a portion of the quorum quenching media 31 of the present disclosure may be disposed in the mesh-shaped container 1320. The quorum quenching media 31 may have a particle size greater than the pore size of the mesh-shaped container 1320 so as to be confined therein.

The quorum quenching module 1300 may be installed in the skid frame 1100 in substantially the same manner as the installation method of the membrane module 1200.

The upper and lower headers 1311 and 1312 of the quorum quenching module 1300 may have substantially the same structure as the upper and lower headers 1211 and 1212 of the membrane module 1200. That is, each of the upper and lower headers 1311 and 1312 of the quorum quenching module 1300 may also have an empty space therein, and may be coupled to the mesh-shaped container 1320 via a potting layer (not shown). In order to prevent the permeate produced by the membrane module 1200 from being introduced into the empty spaces of the upper and lower headers 1311 and 1312 through the cross pipes 1111 and 1121, however, an outlet port of each of the upper and lower headers 1311 and 1312 of the quorum quenching module 1300 may be clogged.

Alternatively, each of the upper and lower headers 1311 and 1312 of the quorum quenching module 1300 may have a structure having no empty space therein, and both ends of the mesh-shaped container 1320 may be coupled to each of the upper and lower headers 1311 and 1312 using a conventional mechanical and/or chemical coupling method.

In sum, the quorum quenching media 31 of the present disclosure may be confined in the predetermined space by means of the mesh-shaped container 32 disposed in the biological treatment unit 20a, 20b, or 20c and/or the membrane unit 40, as illustrated in FIGS. 1(a) to 1(c), or may be confined in the predetermined space inside the membrane unit 40 by means of the mesh-shaped container 1320 of the quorum quenching module 1300 integrated into the membrane filtration apparatus 1000, as illustrated in FIG. 2. Thus, when the waste activated sludge (WAS) or surplus activated sludge (SAS) is discharged from the membrane unit 40 and thus removed from the water treatment system, loss of the quorum quenching media 31 can be prevented or minimized. As a result, the economic feasibility of the water treatment system can be improved. In addition, since the quorum quenching media 31 are spaced apart from the filtration membrane 1220, there is no risk of deterioration of water permeability (i.e. initial water permeability) of the filtration membrane 1220 due to the quorum quenching media 31.

As the solid-liquid separation by the membrane filtration apparatus 1000 is performed, contaminants may adhere to the surface of the filtration membrane 1220, whereby permeation performance of the filtration membrane 1220 may be reduced. Therefore, cleaning is required to separate the contaminants from the surface of the filtration membrane 1220. The cleaning is usually performed using an aeration method of ejecting air supplied from a blower to the filtration membrane through aeration holes of an aeration tube while the water treatment is performed, thereby removing contaminants from the surface of the membrane. However, the cleaning using the aeration method increases the amount of energy consumed by the blower.

In order to overcome the problem of the aeration cleaning, Korean Patent Application Publication No. 10-2018-0062257A (hereinafter referred to as “Prior Art 3”) proposes an apparatus and method capable of preventing or reducing membrane fouling through the reciprocating motion of a filtration membrane in wastewater to be treated. Specifically, Prior Art 3 teaches coupling a plurality of membrane filtration apparatuses to a single reciprocating frame equipped with a plurality of rollers and reciprocating the reciprocating frame along a guide rail using a driving unit during the water treatment, thereby cleaning the filtration membranes of the membrane filtration apparatuses.

The method of Prior Art 3 has an advantage in that the amount of the energy consumption is smaller than that of the aeration cleaning method. However, there is a problem in that all the rollers of the reciprocating frame cannot simultaneously contact with the guide rail due to the flatness difference between the reciprocating frame and the guide rail, which causes load bias toward some rollers in contact with the guide rail and accelerates the wear of the rollers and the breakage of the bearings. In addition, contact and non-contact of the rollers with the guide rail during reciprocating movement of the reciprocating frame repeatedly occur, which causes considerable noise as well as damage to the rollers due to the contact impact.

In accordance with another aspect of the present disclosure, there is provided a membrane unit 40 capable of cleaning the filtration membrane 1220 with a relatively small amount of energy consumption and preventing damage to parts and noise generation as well.

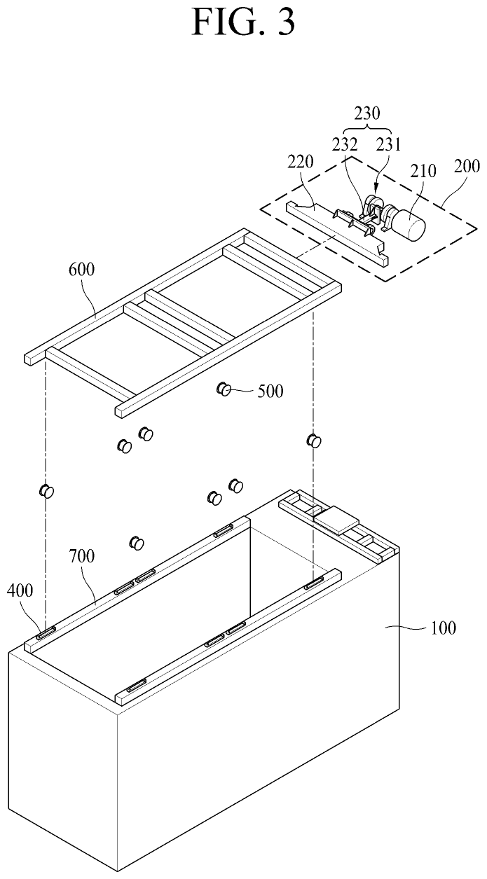

Hereinafter, a membrane unit 40 according to an embodiment of the present disclosure will be described in detail with reference to FIGS. 3 to 5.

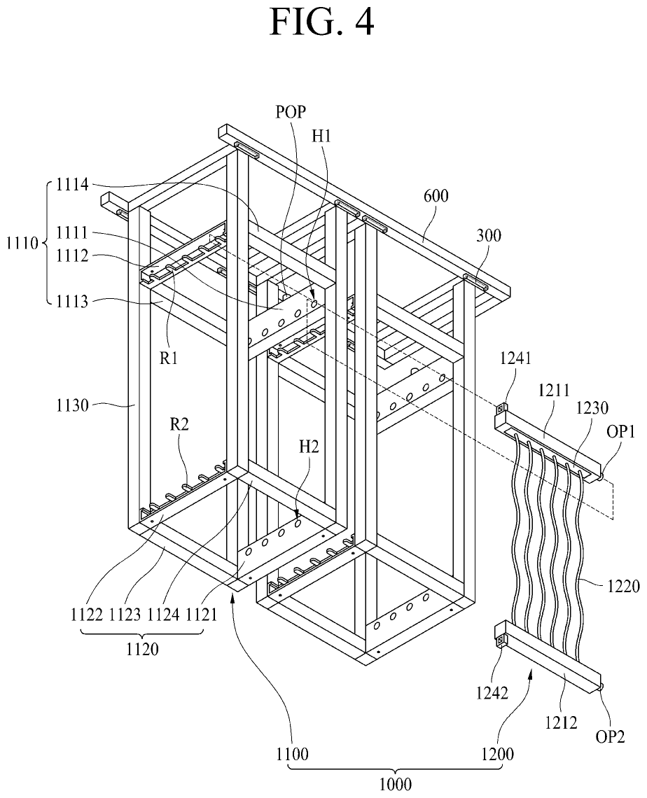

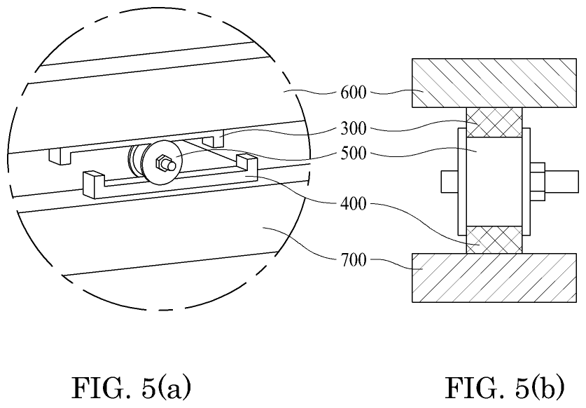

FIG. 3 is an exploded perspective view schematically showing a membrane unit 40 according to an embodiment of the present disclosure, FIG. 4 is an exploded perspective view schematically showing a membrane filtration apparatus 1000 of the membrane unit 40, and FIGS. 5(a) and 5(b) are a perspective view and a sectional view, respectively, schematically showing a guide mechanism of the membrane unit 40.

For simplicity of the drawings and easy understanding of the present disclosure, the membrane filtration apparatus 1000 is omitted from FIG. 3.

As illustrated in FIGS. 3 to 5, the membrane unit 40 according to the embodiment of the present disclosure includes a tank 100 into which wastewater to be treated is introduced, at least one membrane filtration apparatus 1000 configured to perform filtration in the state in which at least a part thereof is submerged in the wastewater, a driving unit 200 for reciprocating motion of the membrane filtration apparatus 1000, a first rail 300 configured to reciprocate together with the membrane filtration apparatus 1000, a second rail 400 configured to guide the reciprocating motion of the membrane filtration apparatus 1000, and a free-roller 500 located between the first and second rails 300 and 400.

Unlike Prior Art 3, in which the plurality of rollers is fixedly coupled to the reciprocating frame, the free-roller 500 of the present disclosure is not fixedly coupled to any frame and is therefore movable relative to both the first and second rails 300 and 400. During filtration, loads of the membrane filtration apparatuses 1000 may be uniformly distributed to the free-rollers 500 of the present disclosure. As a result, the membrane unit 40 according to the present disclosure is capable of (i) cleaning a filtration membrane just with an amount of energy less than required in the aeration cleaning method, (ii) preventing damage to parts (particularly, damage to the roller) which otherwise might be caused due to the biased load, thereby dramatically reducing operation and maintenance costs, and (iii) inhibiting noise generation during the filtration. The membrane unit 40 according to the embodiment of the present disclosure further includes a reciprocating frame 600 to which the plurality of membrane filtration apparatuses 1000 is individually coupled. The driving unit 200 is configured to implement the reciprocating motion of the membrane filtration apparatuses 1000 through the reciprocating frame 600.

As illustrated in FIG. 3, the driving unit 200 may include a motor 210, a power transmission member 220 connected to the reciprocating frame 600, and a motion conversion mechanism 230 configured to convert rotational motion of the motor 210 into linear reciprocating motion of the power transmission member 220.

The motion conversion mechanism 230 may be a crank-rod mechanism. That is, the motion conversion mechanism 230 may include a crankshaft 231 rotatable by the motor 210 and a connecting rod 232 having one end connected to the crankshaft 231 and the other end connected to the power transmission member 220. Alternatively, the motion conversion mechanism 230 may be a cam-follower mechanism.

As illustrated in FIG. 4, each of the plurality of membrane filtration apparatuses 1000 coupled to the reciprocating frame 600 may include a skid frame 1100 and a plurality of membrane modules 1200 installed therein. Although not shown in FIG. 4, at least one of the membrane filtration apparatuses 1000 may further include at least one quorum quenching module 1300 installed in the skid frame 1100, as described above.

The skid frame 1100 may include an upper horizontal frame 1110, a lower horizontal frame 1120, and a plurality of vertical members 1130 connecting the upper horizontal frame 1110 and the lower horizontal frame 1120 to each other. The skid frame 1100 may be coupled to the reciprocating frame 600 using a variety of known methods.

For example, as illustrated in FIG. 4, the vertical members 1130 may extend past the upper horizontal frame 1110, and these extensions may be coupled to the reciprocating frame 600. As a result, even when the driving unit 200, the reciprocating frame 600, the first and second rails 300 and 400, and the free-roller 500 are not submerged in the wastewater in the tank 100, the membrane modules 1200 of the membrane filtration apparatus 1000 can be submerged in the wastewater to perform filtration. Consequently, it is possible to minimize the number of parts that should be submerged in the wastewater and are thus vulnerable to corrosion and to minimize the need to separately perform a corrosion-inhibiting chemical treatment.

Although not shown, in order to increase mechanical durability, the skid frame 1100 may further include a plurality of reinforcing rods configured to connect the vertical members 1130 and the upper and lower horizontal frames 1110 and 1120 to each other in various ways.

Each of the membrane modules 1200 may include an upper header 1211 having a first outlet port OP1 at one end thereof, a lower header 1212 having a second outlet port OP2 at one end thereof, and a filtration membrane 1220 configured to fluidly communicate with the upper header 1211 and the lower header 1212.

One end and the other end of the filtration membrane 1220 are fixed to the upper header 1211 and the lower header 1212 via potting layers 1230, respectively. The filtration membrane 1220 fluidly communicates with the upper header 1211 and the lower header 1212, whereby the permeate passing through the filtration membrane 1220 is introduced into the water-collecting spaces of the upper header 1211 and the lower header 1212. Subsequently, the permeate is discharged from the membrane module 1200 through the first outlet port OP1 of the upper header 1211 and the second outlet port OP2 of the lower header 1212.

Although a hollow fiber membrane having a longitudinal direction parallel to the vertical members 1130 is illustrated as the filtration membrane 1220 in FIG. 4, the filtration membrane 1220 of the present disclosure is not limited thereto, and may be a flat sheet membrane.

The upper header 1211 and the lower header 1212 are coupled to the upper horizontal frame 1110 and the lower horizontal frame 1120, respectively, whereby the membrane module 1200 is installed in the skid frame 1100.

Specifically, the upper horizontal frame 1110 may include an upper cross pipe 1111 to which one end of the upper header 1211 is coupled via the first outlet port OP1, an upper cross bar 1112 to which the other end of the upper header 1211 is coupled, a first upper horizontal member 1113 configured to connect one end of the upper cross pipe 1111 and one end of the upper cross bar 1112 to each other, and a second upper horizontal member 1114 configured to connect the other end of the upper cross pipe 1111 and the other end of the upper cross bar 1112 to each other. The first outlet port OP1 of the upper header 1211 is inserted into a first hole H1 of the upper cross pipe 1111, whereby one end of the upper header 1211 is coupled to the upper cross pipe 1111. The permeate discharged from the upper header 1211 through the first outlet port OP1 is introduced into the upper cross pipe 1111 and then flows out through a permeate outlet port POP.

Similarly, the lower horizontal frame 1120 may include a lower cross pipe 1121 to which one end of the lower header 1212 is coupled via the second outlet port OP2, a lower cross bar 1122 to which the other end of the lower header 1212 is coupled, a first lower horizontal member 1123 configured to connect one end of the lower cross pipe 1121 and one end of the lower cross bar 1122 to each other, and a second lower horizontal member 1124 configured to connect the other end of the lower cross pipe 1121 and the other end of the lower cross bar 1122 to each other. The second outlet port OP2 of the lower header 1212 is inserted into a second hole H2 of the lower cross pipe 1121, whereby one end of the lower header 1212 is coupled to the lower cross pipe 1121. The permeate discharged from the lower header 1212 through the second outlet port OP2 is introduced into the lower cross pipe 1121.

At least one of the vertical members 1130, which connect the upper cross pipe 1111 and the lower cross pipe 1121 to each other, may have a pipe shape that fluidly communicates therewith, whereby the permeate introduced into the lower cross pipe 1121 may flow into the upper cross pipe 1111 and then be discharged to the outside through the permeate outlet port POP.

Alternatively, a separate permeate outlet port may be provided at the lower cross pipe 1121 such that the permeate introduced into the lower cross pipe 1121 is discharged to the outside therethrough.

The other end of the upper header 1211 is coupled to the upper cross bar 1112. For example, as illustrated in FIG. 4, a first rib R1 provided at the upper cross bar 1112 may be inserted into a first receiving member 1241 provided at the other end of the upper header 1211, whereby the other end of the upper header 1211 may be coupled to the upper cross bar 1112.

Similarly, a second rib R2 provided at the lower cross bar 1122 may be inserted into a second receiving member 1242 provided at the other end of the lower header 1212, whereby the other end of the lower header 1212 may be coupled to the lower cross bar 1122.

The reciprocating frame 600, to which each of the plurality of membrane filtration apparatuses 1000 is coupled, has a bottom surface that faces the free-roller 500, and the first rail 300 is mounted on the bottom surface of the reciprocating frame 600. When the reciprocating frame 600 is reciprocated by the driving unit 200, therefore, the first rail 300 of the present disclosure may reciprocate together with the membrane filtration apparatuses 1000.

As illustrated in FIGS. 3 and 5, the membrane unit 40 may further include a guide frame 700 provided on the tank 100. The guide frame 700 may have a top surface that faces the free-roller 500, and the second rail 400 may be mounted on the top surface of the guide frame 700.

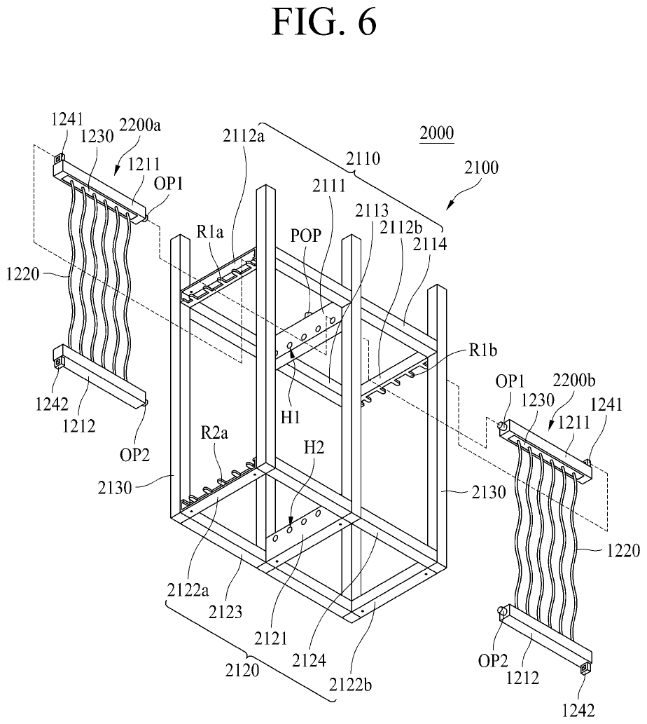

FIG. 6 is an exploded perspective view schematically showing a double-deck type membrane filtration apparatus 2000 according to another embodiment of the present disclosure.

As illustrated in FIG. 6, a double-deck type membrane filtration apparatus 2000 includes a skid frame 2100 having first and second interior spaces, first membrane modules 2200a installed in the first interior space, and second membrane modules 2200b installed in the second interior space. Although not shown in FIG. 6, the membrane filtration apparatus 2000 may further include at least one quorum quenching module 1300 installed in the first interior space and/or the second interior space, as described above.

The skid frame 2100 may include an upper horizontal frame 2110, a lower horizontal frame 2120, and a plurality of vertical members 2130 configured to connect the upper horizontal frame 2110 and the lower horizontal frame 2120 to each other. The vertical members 2130 may extend past the upper horizontal frame 2110, and these extensions may be coupled to the reciprocating frame 600.

Although not shown, in order to increase mechanical durability, the skid frame 2100 may further include a plurality of reinforcing rods configured to connect the vertical members 2130 and the upper and lower horizontal frames 2110 and 2120 to each other in various ways.

Each of the first and second membrane modules 2200a and 2200b may include an upper header 1211 having a first outlet port OP1 at one end thereof, a lower header 1212 having a second outlet port OP2 at one end thereof, and a filtration membrane 1220 configured to fluidly communicate with the upper header 1211 and the lower header 1212.

One end and the other end of the filtration membrane 1220 are fixed respectively to the upper header 1211 and the lower header 1212 via potting layers 1230. The filtration membrane 1220 fluidly communicates with the upper header 1211 and the lower header 1212, whereby the permeate passing through the filtration membrane 1220 is introduced into the water-collecting spaces of the upper header 1211 and the lower header 1212. Subsequently, the permeate is discharged from each of the first and second membrane modules 2200a and 2200b through the first outlet port OP1 of the upper header 1211 and the second outlet port OP2 of the lower header 1212.

Although a hollow fiber membrane having a longitudinal direction parallel to the vertical members 2130 is illustrated as the filtration membrane 1220 in FIG. 6, the filtration membrane 1220 of the present disclosure is not limited thereto, and may be a flat sheet membrane.

The upper header 1211 and the lower header 1212 are coupled respectively to the upper horizontal frame 2110 and the lower horizontal frame 2120, whereby each of the first and second membrane modules 2200a and 2200b is mounted on the skid frame 2100.

Specifically, the upper horizontal frame 2110 may include a common upper cross pipe 2111, first and second upper cross bars 2112a and 2112b, a first upper horizontal member 2113 configured to connect one end of the common upper cross pipe 2111 and one end of each of the first and second upper cross bars 2112a and 2112b to each other, and a second upper horizontal member 2114 configured to connect the other end of the common upper cross pipe 2111 and the other end of each of the first and second upper cross bars 2112a and 2112b to each other. The common upper cross pipe 2111 has a longitudinal direction parallel to the first and second upper cross bars 2112a and 2112b, and is disposed between the first and second upper cross bars 2112a and 2112b.

The common upper cross pipe 2111 has first holes H1 formed in each of the surface thereof that faces the first upper cross bar 2112a and the opposite surface thereof (i.e. the surface thereof that faces the second upper cross bar 2112b). The first outlet ports OP1 of the first and second membrane modules 2200a and 2200b are inserted into the first holes H1, respectively, whereby one end of each of the upper headers 1211 of the first and second membrane modules 2200a and 2200b is coupled to the common upper cross pipe 2111. The permeate discharged through the first outlet port OP1 of each of the first and second membrane modules 2200a and 2200b is introduced into the common upper cross pipe 2111 and then flows out through a permeate outlet port POP.

Similarly, the lower horizontal frame 2120 may include a common lower cross pipe 2121, first and second lower cross bars 2122a and 2122b, a first lower horizontal member 2123 configured to connect one end of the common lower cross pipe 2121 and one end of each of the first and second lower cross bars 2122a and 2122b to each other, and a second lower horizontal member 2124 configured to connect the other end of the common lower cross pipe 2121 and the other end of each of the first and second lower cross bars 2122a and 2122b to each other. The common lower cross pipe 2111 has a longitudinal direction parallel to the first and second lower cross bars 2122a and 2122b, and is disposed between the first and second lower cross bars 2122a and 2122b.

The common lower cross pipe 2121 has second holes H2 formed in each of the surface thereof that faces the first lower cross bar 2122a and the opposite surface thereof (i.e. the surface thereof that faces the second lower cross bar 2122b). The second outlet ports OP2 of the first and second membrane modules 2200a and 2200b are inserted into the second holes H2, respectively, whereby one end of each of the lower headers 1212 of the first and second membrane modules 2200a and 2200b is coupled to the common lower cross pipe 2121. The permeate discharged through the second outlet port OP2 of each of the first and second membrane modules 2200a and 2200b is introduced into the common lower cross pipe 2121.

At least one of the vertical members 2130, which connect the common upper cross pipe 2111 and the common lower cross pipe 2121 to each other, may have a pipe shape that fluidly communicates therewith, whereby the permeate introduced into the common lower cross pipe 2121 may flow into the common upper cross pipe 2111 and then be discharged to the outside through the permeate outlet port POP.

Alternatively, a separate permeate outlet port may be provided at the common lower cross pipe 2121 such that the permeate introduced into the common lower cross pipe 2121 is discharged to the outside therethrough.

The other ends of the upper headers 1211 of the first and second membrane modules 2200a and 2200b are coupled to the first and second upper cross bars 2112a and 2112b, respectively. For example, as illustrated in FIG. 6, the first ribs R1 provided at the first and second upper cross bars 2112a and 2112b are inserted into the first receiving members 1241 provided at the other ends of the upper headers 1211 of the first and second membrane modules 2200a and 2200b, whereby the other ends of the upper headers 1211 of the first and second membrane modules 2200a and 2200b may be coupled to the first and second upper cross bars 2112a and 2112b, respectively.

Similarly, the second ribs R2 provided at the first and second lower cross bars 2122a and 2122b are inserted into the second receiving members 1242 provided at the other ends of the lower headers 1212 of the first and second membrane modules 2200a and 2200b, whereby the other ends of the lower headers 1212 of the first and second membrane modules 2200a and 2200b may be coupled to the first and second lower cross bars 2122a and 2122b, respectively.

Thanks to the increase in the degree of integration of the membrane modules 2200a and 2200b in the skid frame 2100, the double-deck type membrane filtration apparatus 2000 has an improved recovery rate.

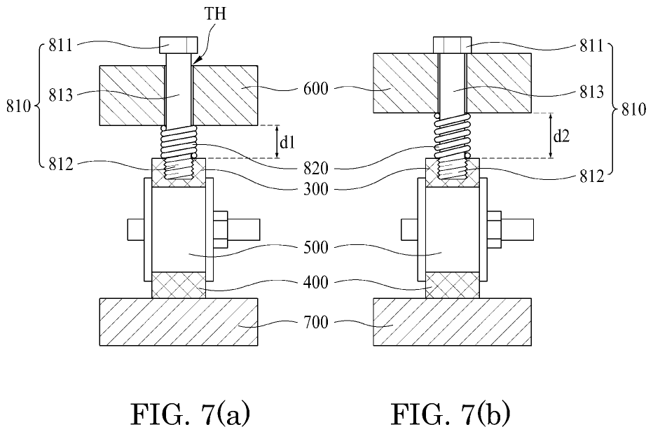

FIGS. 7(a) and 7(b) are sectional views schematically showing a guide mechanism according to another embodiment of the present disclosure.

According to the other embodiment of the present disclosure, the first rail 300 may be elastically mounted on the bottom surface of the reciprocating frame 600 such that the distance between the first rail 300 and the reciprocating frame 600 is variable (i.e. d1<—>d2).

Specifically, as illustrated in FIGS. 7(a) and 7(b), the reciprocating frame 600 may have a through-hole TH extending from a top surface thereof, which is opposite the bottom surface thereof, to the bottom surface, and the first rail 300 may be mounted on the bottom surface of the reciprocating frame 600 by means of a coupling member 810. The coupling member 810 may include a head 811 located over the top surface of the reciprocating frame 600, a screw end 812 inserted into the first rail 300, and a central body 813 between the head 811 and the screw end 812.

The central body 813 is movable along the through-hole TH, and has a length longer than the through-hole TH. An elastic member 820 is interposed between the reciprocating frame 600 and the first rail 300. For example, the central body 813 may include an exposed portion between the bottom surface of the reciprocating frame 600 and the first rail 300, and the elastic member 820 may be a spring surrounding the exposed portion.

The free-roller 500 of the present disclosure, which is not fixedly coupled to any frame, may always keep in contact with the second rail 400 on the guide frame 700 by virtue of gravity. On the other hand, due to the flatness difference between the reciprocating frame 600 and the guide frame 700, the contact between the first rail 300 mounted on the bottom surface of the reciprocating frame 600 and the free-roller 500 cannot always be maintained. According to the guide mechanism of the aforementioned embodiment of the present disclosure, however, even if the gap between a certain portion of the reciprocating frame 600 and the guide frame 700 temporarily increases during the reciprocating motion due to the flatness difference between the reciprocating frame 600 and the guide frame 700, the first rail 300 corresponding to the portion can move toward the corresponding free-roller 500 thanks to the elastic force of the elastic member 820 such that the contact between the first rail 300 and the free-roller 500 can always be secured. Therefore, it is possible to prevent any damage of the free-rollers 500 that otherwise might be caused due to load bias to some of the free-rollers 500. In addition, damage to the free-roller 500 and noise generation due to repeated contact and non-contact between the first rail 300 and the free-roller 500 may also be avoided.

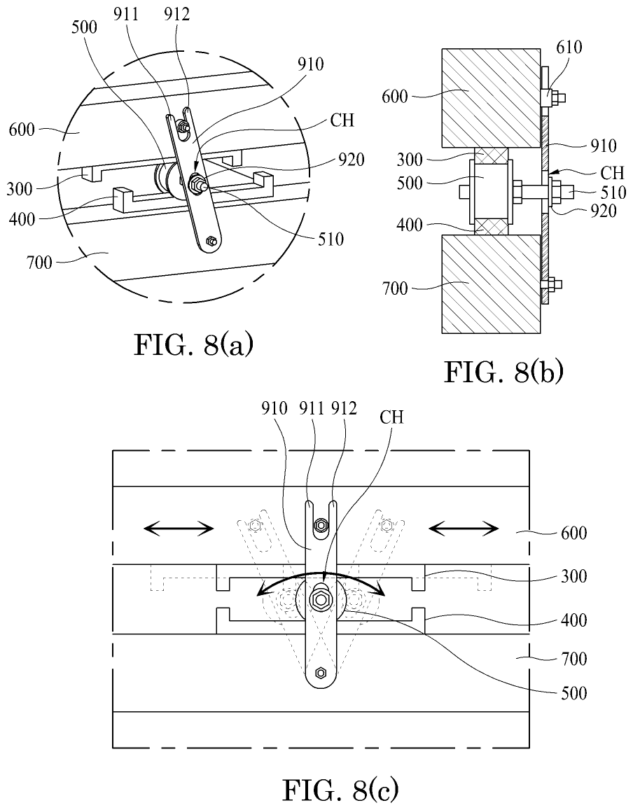

FIGS. 8(a), 8(b), and 8(c) are a perspective view, a sectional view, and a front view, respectively, schematically showing a guide mechanism according to a further another embodiment of the present disclosure.

As illustrated in FIG. 8, the membrane unit 40 of the present disclosure may further include a pivot member 910 having a central hole CH. A first end of the pivot member 910 may be pivotably coupled to the guide frame 700, and a second end of the pivot member 910 may be a two-pronged end having first and second fingers 911 and 912.

A rotating shaft 510 connected to the rotation axis of the free-roller 500 may extend through the central hole CH of the pivot member 910, and a protrusion 610 provided at the reciprocating frame 600 may be disposed in the gap between the first and second fingers 911 and 912. The protrusion 610 may be a circular ring member coupled to the reciprocating frame 600 by means of a screw.

The reciprocating motion of the reciprocating frame 600 performed by the driving unit 200 causes (i) rotational and reciprocating motion of the free-roller 500, (ii) pivoting motion of the pivot member 910, and (iii) reciprocating motion of the protrusion 610 relative to the pivot member 910 in the gap between the first and second fingers 911 and 912 (i.e., reciprocating motion along a longitudinal direction of the gap).

The aforementioned pivot member 910 can prevent the free-roller 500 of the present disclosure from being separated from the membrane unit 40. Optionally, the membrane unit 40 may further include a separation-preventing member 920 coupled to an end of the rotating shaft 510 such that the central hole CH of the pivot member 910 is between the free-roller 500 and the separation-preventing member 920.

The membrane unit 40 of the present disclosure may employ only one of the guide mechanisms of FIG. 7 and FIG. 8, or may employ a combination thereof.

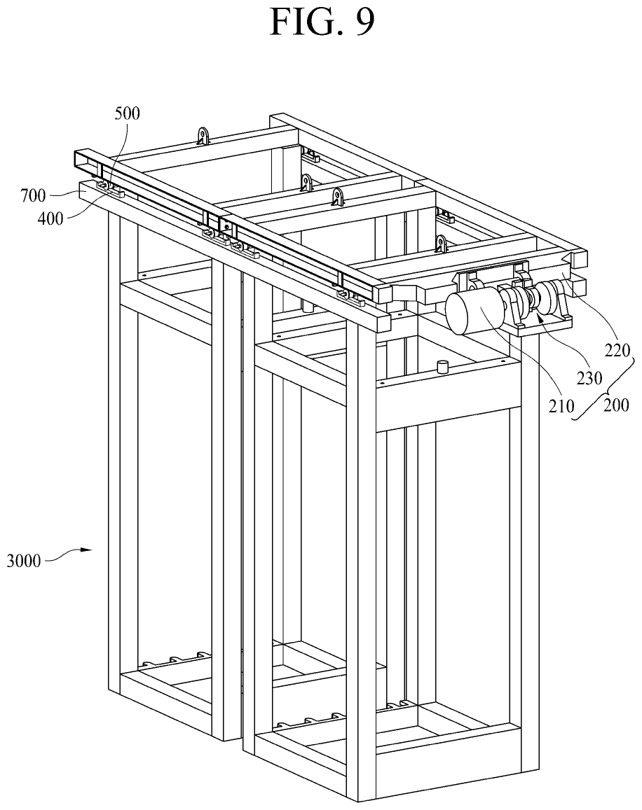

Hereinafter, a membrane unit 40 according to another embodiment of the present disclosure will be described in detail with reference to FIGS. 9 to 11.

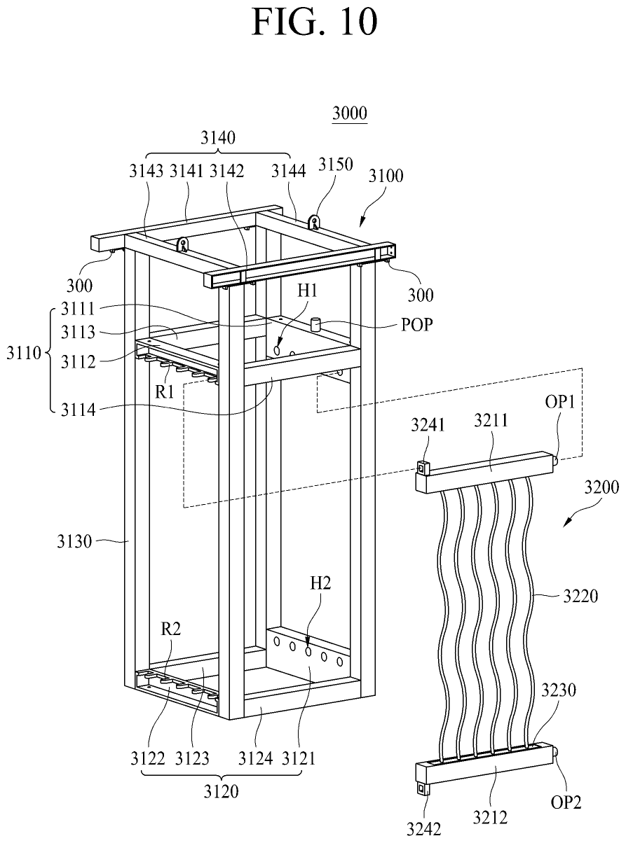

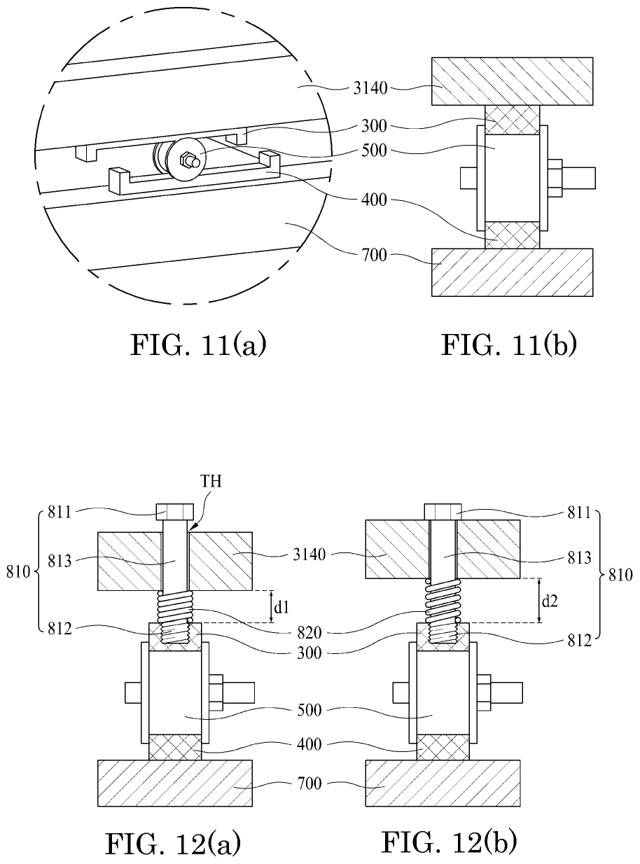

FIG. 9 is a perspective view schematically showing a membrane unit 40 according to another embodiment of the present disclosure, FIG. 10 is an exploded perspective view schematically showing a membrane filtration apparatus 3000 of the membrane unit 40, and FIGS. 11(a) and 11(b) are a perspective view and a sectional view, respectively, schematically showing a guide mechanism of the membrane unit 40.

It should be noted that, for simplicity of the drawings and easy understanding of the present disclosure, a tank and a membrane module are omitted from FIG. 9.

As illustrated in FIGS. 9 to 11, the membrane unit 40 according to the other embodiment of the present disclosure includes a plurality of membrane filtration apparatuses 3000 configured to perform filtration in the state in which at least a part thereof is submerged in wastewater introduced into a tank (not shown), a driving unit 200 for reciprocating motion of the membrane filtration apparatuses 3000, first rails 300 configured to reciprocate together with the membrane filtration apparatuses 3000, second rails 400 configured to guide the reciprocating motion of the membrane filtration apparatuses 3000, and free-rollers 500 located between the first and second rails 300 and 400.

Similarly to the aforementioned membrane unit 40 according to the embodiment of the present disclosure, the free-roller 500 is not fixedly coupled to any frame and is therefore movable relative to both the first and second rails 300 and 400. In addition, loads of the membrane filtration apparatuses 3000 may be uniformly distributed to the free-rollers 500 of the present disclosure during the filtration. As a result, the membrane unit 40 according to the other embodiment of the present disclosure is also capable of (i) cleaning a filtration membrane jus with an amount of energy less than required in an aeration cleaning method, (ii) preventing damage to parts (particularly, damage to the roller) which otherwise might be caused due to the biased load, thereby dramatically reducing operation and maintenance costs, and (iii) inhibiting noise generation during the filtration.

As illustrated in FIG. 10, each of the membrane filtration apparatuses 3000 may include a skid frame 3100 and a plurality of membrane modules 3200 installed therein. Although not shown in FIG. 10, at least one of the membrane filtration apparatuses 3000 may further include at least one quorum quenching module 1300 installed in the skid frame 3100, as described above.

The skid frame 3100 may include a supporting frame 3140, a lower horizontal frame 3120, an upper horizontal frame 3110 located between the supporting frame 3140 and the lower horizontal frame 3120, and a plurality of vertical members 3130 configured to connect the supporting frame 3140, the upper horizontal frame 3110, and the lower horizontal frame 3120 to each other.

Although not shown, in order to increase mechanical durability, the skid frame 3100 may further include a plurality of reinforcing rods configured to connect the supporting frame 3140, the upper and lower horizontal frames 3110 and 3120, and the vertical members 3130 to each other in various ways.

The supporting frame 3140 may have a bottom surface that faces the free-roller 500, and the first rail 300 may be mounted on the bottom surface of the supporting frame 3140. Therefore, when the membrane filtration apparatus 3000 is reciprocated by the driving unit 200, the first rail 300 of the present disclosure can reciprocate together with the membrane filtration apparatuses 3000.

Each of the membrane modules 3200 may include an upper header 3211 having a first outlet port OP1 at one end thereof, a lower header 3212 having a second outlet port OP2 at one end thereof, and a filtration membrane 3220 configured to fluidly communicate with the upper header 3211 and the lower header 3212.

One end and the other end of the filtration membrane 3220 are fixed to the upper and lower headers 3211 and 3212, respectively, via potting layers 3230. The filtration membrane 3220 fluidly communicates with the upper and lower headers 3211 and 3212, whereby the permeate passing through the filtration membrane 3220 is introduced into the water-collecting spaces of the upper and lower headers 3211 and 3212. Subsequently, the permeate is discharged from the membrane module 3200 through the outlet ports OP1 and OP2 of the upper and lower headers 3211 and 3212.

The upper and lower headers 3211 and 3212 are coupled to the upper and lower horizontal frames 3110 and 3120, respectively, whereby the membrane module 3200 is installed in the skid frame 3100.

Specifically, the upper horizontal frame 3110 may include an upper cross pipe 3111 to which one end of the upper header 3211 is coupled via the first outlet port OP1, an upper cross bar 3112 to which the other end of the upper header 3211 is coupled, a first upper horizontal member 3113 configured to connect one end of the upper cross pipe 3111 and one end of the upper cross bar 3112 to each other, and a second upper horizontal member 3114 configured to connect the other end of the upper cross pipe 3111 and the other end of the upper cross bar 3112 to each other. The first outlet port OP1 of the upper header 3211 is inserted into a first hole H1 of the upper cross pipe 3111, whereby the one end of the upper header 3211 is coupled to the upper cross pipe 3111. The permeate discharged from the upper header 3211 through the first outlet port OP1 is introduced into the upper cross pipe 3111 and then flows out through a permeate outlet port POP.

Similarly, the lower horizontal frame 3120 may include a lower cross pipe 3121 to which one end of the lower header 3212 is coupled via the second outlet port OP2, a lower cross bar 3122 to which the other end of the lower header 3212 is coupled, a first lower horizontal member 3123 configured to connect one end of the lower cross pipe 3121 and one end of the lower cross bar 3122 to each other, and a second lower horizontal member 3124 configured to connect the other end of the lower cross pipe 3121 and the other end of the lower cross bar 3122 to each other. The second outlet port OP2 of the lower header 3212 is inserted into a second hole H2 of the lower cross pipe 3121, whereby the one end of the lower header 3212 is coupled to the lower cross pipe 3121. The permeate discharged from the lower header 3212 through the second outlet port OP2 is introduced into the lower cross pipe 3121.

At least one of the vertical members 3130, which connect the upper cross pipe 3111 and the lower cross pipe 3121 to each other, may have a pipe shape that fluidly communicates therewith, such that the permeate introduced into the lower cross pipe 3121 can flow into the upper cross pipe 3111 and then be discharged to the outside through the permeate outlet port POP.

Alternatively, a separate permeate outlet port may be provided at the lower cross pipe 3121 such that the permeate introduced into the lower cross pipe 3121 is discharged to the outside therethrough.

The other end of the upper header 3211 is coupled to the upper cross bar 3112. For example, as illustrated in FIG. 10, a first rib R1 provided at the upper cross bar 3112 may be inserted into a first receiving member 3241 provided at the other end of the upper header 3211, whereby the other end of the upper header 3211 may be coupled to the upper cross bar 3112.

Similarly, a second rib R2 provided at the lower cross bar 3122 may be inserted into a second receiving member 3242 provided at the other end of the lower header 3212, whereby the other end of the lower header 3212 may be coupled to the lower cross bar 3122.

According to the membrane unit 40, the supporting frame 3140 is disposed above the upper and lower horizontal frames 3110 and 3120 to which the membrane modules 3200 are coupled, and the first rail 300 is mounted on the supporting frame 3140. Therefore, even when the driving unit 200, the supporting frame 3140, the first and second rails 300 and 400, the free-roller 500, etc. are not submerged in the wastewater, the membrane modules 3200 of the membrane filtration apparatus 3000 can be submerged in the wastewater to perform filtration. Consequently, it is possible to minimize the number of parts that should be submerged in the wastewater and are thus vulnerable to corrosion and to minimize the need to separately perform a corrosion-inhibiting chemical treatment.

Instead of the membrane filtration apparatus 3000 illustrated in FIG. 10, a membrane filtration apparatus provided by coupling the supporting frame 3140 to the double-deck type membrane filtration apparatus 2000 illustrated in FIG. 6 may be used. Even in this case, the first rail 300 is mounted on the bottom surface of the supporting frame 3140.

As illustrated in FIG. 10, the supporting frame 3140 of the skid frame 3100 may include a pair of parallel bars 3141 and 3142 on each of which the first rail 300 is mounted and at least one connecting bar 3143 and/or 3144 configured to connect the pair of parallel bars 3141 and 3142 to each other, and the vertical members 3130 may be coupled to the connecting bar 3143 and/or 3144.

As illustrated in FIGS. 9 and 11, the membrane unit 40 may further include a guide frame 700 provided on the tank (not shown), the guide frame 700 may have a top surface that faces the free-roller 500, and the second rail 400 may be mounted on the top surface of the guide frame.

As illustrated in FIG. 9, the driving unit 200 may include a motor 210, a power transmission member 220 connected to the membrane filtration apparatus 3000, and a motion conversion mechanism 230 configured to convert rotational motion of the motor 210 into linear reciprocating motion of the power transmission member 220.

The motion conversion mechanism 230 may be a crank-rod mechanism. That is, the motion conversion mechanism 230 may include a crankshaft rotatable by the motor 210 and a connecting rod having one end connected to the crankshaft and the other end connected to the power transmission member 220. Alternatively, the motion conversion mechanism 230 may be a cam-follower mechanism.

The membrane unit 40 of the embodiment illustrated in FIG. 9 includes a plurality of membrane filtration apparatuses 3000 arranged side by side in the direction of the linear reciprocating motion. For example, the power transmission member 220 of the driving unit 200 is directly coupled to the supporting frame of the first membrane filtration apparatus, and the supporting frame of the first membrane filtration apparatus is directly coupled to the supporting frame of the second membrane filtration apparatus. Consequently, the driving unit 200 becomes a direct driving source for reciprocating movement of the first membrane filtration apparatus, and the first membrane filtration apparatus becomes a direct driving source for reciprocating movement of the second membrane filtration apparatus. That is, the driving unit 200 acts as an indirect driving source for the membrane filtration apparatus(es) other than the membrane filtration apparatus directly coupled thereto.

The supporting frame 3140 of each membrane filtration apparatuse 3000 may be detachably coupled to the power transmission member 220 and/or the support frame(s) 3140 of other membrane filtration apparatus(es) by means of, for example, bolts. If any one of the plurality of membrane filtration apparatuses 3000 is damaged, therefore, it is possible to remove only the damaged filtration apparatus from the tank for repair or replacement. As a result, maintenance of the membrane unit 40 may be easily performed at a relatively low cost. In order to easily remove only the damaged membrane filtration apparatus from the tank, each of the membrane filtration apparatuses 3000 may further include a lifting hook receiver 3150 provided on the supporting frame 3140.

The membrane unit 40 according to the embodiment illustrated in FIGS. 9 to 11 is different from Prior Art 3 and the membrane unit 40 according to the embodiment illustrated in FIGS. 3 to 5 in that no “reciprocating frame” is used. Since the reciprocating frame needs to be large enough to allow a plurality of membrane filtration apparatuses to be simultaneously connected thereto, (i) there is inconvenience in that the transportation constraints such as traffic regulations require the respective parts of the reciprocating frame to be transported individually to a water treatment site and then assembled into a complete reciprocating frame by welding, and (ii) there are difficulty and inconvenience in that, even when a part of only one membrane filtration apparatus (e.g. a membrane module) is damaged, it is necessary to simultaneously lift the heavy reciprocating frame and all membrane filtration apparatuses connected thereto as well, for the repair of the damaged part. On the other hand, according to the embodiment illustrated in FIGS. 9 to 11, which does not employ a reciprocating frame, (i) transportation of the reciprocating frame by parts and welding thereof at the water treatment site may be omitted, whereby it is possible to easily install the membrane unit 40 at a relatively low cost, and (ii) when a certain membrane filtration apparatus is damaged during filtration, only the damaged membrane filtration apparatus can be separated and removed from the tank, whereby maintenance of the membrane unit 40 is relatively easy and it is possible to dramatically reduce the cost.

FIGS. 12(a) and 12(b) are sectional views schematically showing a guide mechanism according to another embodiment of the present disclosure.

According to the other embodiment of the present disclosure, the first rail 300 may be elastically mounted on the bottom surface of the supporting frame 3140 such that the distance between the first rail 300 and the supporting frame 3140 of the membrane filtration apparatus 3000 is variable (i.e. d1<—>d2).

Specifically, as illustrated in FIG. 12, the supporting frame 3140 may have a through-hole TH extending from a top surface thereof, which is opposite the bottom surface, to the bottom surface, and the first rail 300 may be mounted on the bottom surface of the supporting frame 3140 by means of a coupling member 810. The coupling member 810 may include a head 811 located over the top surface of the supporting frame 3140, a screw end 812 inserted into the first rail 300, and a central body 813 located between the head 811 and the screw end 812.

The central body 813 is movable along the through-hole TH, and has a length longer than the through-hole TH. An elastic member 820 is interposed between the supporting frame 3140 and the first rail 300. For example, the central body 813 may include an exposed portion between the bottom surface of the supporting frame 3140 and the first rail 300, and the elastic member 820 may be a spring surrounding the exposed portion.

The free-roller 500 of the present disclosure, which is not fixedly coupled to any frame, may always keep in contact with the second rail 400 on the guide frame 700 by virtue of gravity. On the other hand, due to the flatness difference between the supporting frame 3140 and the guide frame 700, the contact between the first rail 300 mounted on the bottom surface of the supporting frame 3140 and the free-roller 500 cannot always be maintained. According to the aforementioned guide mechanism of the other embodiment of the present disclosure, however, even if the gap between a certain portion of the supporting frame 3140 and the guide frame 700 temporarily increases during the reciprocating motion due to the flatness difference between the supporting frame 3140 and the guide frame 700, the first rail 300 corresponding to the portion can move toward the corresponding free-roller 500 thanks to the elastic force of the elastic member 820, such that the contact between the first rail 300 and the free-roller 500 can always be secured. Therefore, it is possible to prevent any damage of the free-rollers 500 that otherwise might be caused due to load bias to some of the free-rollers 500. In addition, damage to the free-roller 500 and noise generation due to repeated contact and non-contact between the first rail 300 and the free-roller 500 may also be prevented.

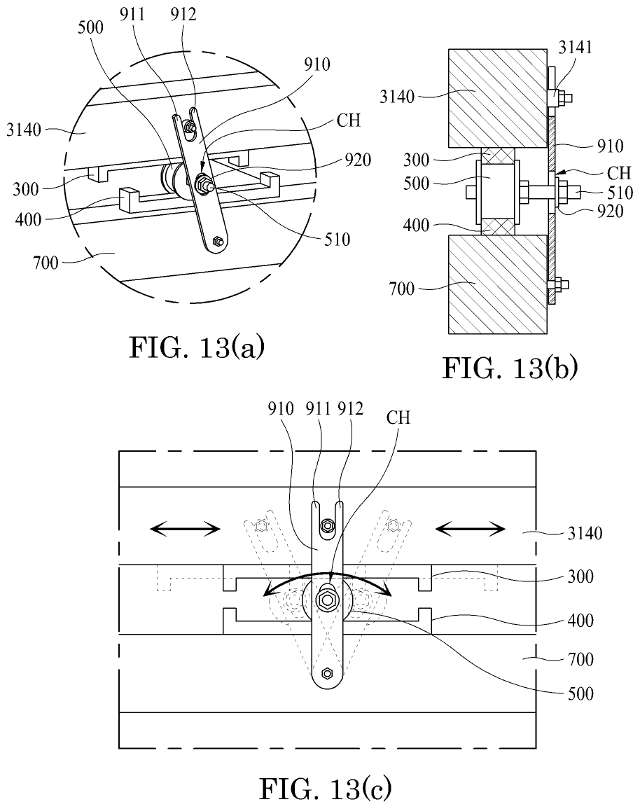

FIGS. 13(a), 13(b), and 11(c) are a perspective view, a sectional view, and a front view, respectively, schematically showing a guide mechanism according to a further embodiment of the present disclosure.

As illustrated in FIG. 13, the membrane unit 40 may further include a pivot member 910 having a central hole CH. A first end of the pivot member 910 may be pivotably coupled to the guide frame 700, and a second end of the pivot member 910 may be a two-pronged end having first and second fingers 911 and 912.

A rotating shaft 510 connected to the rotation axis of the free-roller 500 may extend through the central hole CH of the pivot member 910, and a protrusion 3141 provided at the supporting frame 3140 may be disposed in the gap between the first and second fingers 911 and 912. The protrusion 3141 may be a circular ring member coupled to the supporting frame 3140 by means of a screw.

Since a two-pronged end is employed as the second end of the pivot member 910 instead of an end having an elongated hole, it is possible to prevent the protrusion 3141 from acting as an obstacle when only the damaged membrane filtration apparatus 3000 is separated and removed.

The reciprocating motion of the membrane filtration apparatus 3000 performed by the driving unit 200 causes (i) rotational and reciprocating motion of the free-roller 500, (ii) pivoting motion of the pivot member 910, and (iii) reciprocating motion of the protrusion 3141 relative to the pivot member 910 in the gap between the first and second fingers 911 and 912 (i.e., reciprocating motion alone a longitudinal direction of the gap).

The aforementioned pivot member 910 can prevent the free-roller 500 of the present disclosure from being separated from the membrane unit 40. Optionally, the membrane unit 40 may further include a separation-preventing member 920 coupled to an end of the rotating shaft 510 such that the central hole CH of the pivot member 910 is between the free-roller 500 and the separation-preventing member 920.

The guide mechanism of FIG. 12 and the guide mechanism of FIG. 13 may be employed independently from each other or in combination.

According to the present disclosure, the biological treatment unit and/or the membrane unit includes the quorum quenching media, whereby it is possible to prevent biofilm formation and resulting membrane fouling, which otherwise might be caused due to the quorum sensing of the microbes. In addition, since the quorum quenching media are confined in a predetermined space in the biological treatment unit and/or the membrane unit, it is possible to prevent the quorum quenching media from being removed together with the waste activated sludge (WAS) or the surplus activated sludge (SAS) when the WAS or SAS is discharged from the membrane unit and is thus removed from the water treatment system. Unlike Prior Art 1, therefore, the present disclosure is capable of preventing or minimizing the loss of the quorum quenching media, thereby improving the economic feasibility of the water treatment system. Furthermore, according to the present disclosure, unlike Prior Art 2, the quorum quenching media are confined in a predetermined space while being spaced apart from the filtration membrane, such that water permeability (i.e. initial water permeability) of the filtration membrane itself is not adversely affected by the quorum quenching media.

In addition, according to an embodiment of the present disclosure, cleaning of the filtration membrane in the membrane unit is performed with a membrane-reciprocating method, rather than an aeration method, whereby energy consumption can be dramatically reduced. Furthermore, another embodiment of the present disclosure adopts a novel concept of a “free-roller” that is not fixedly coupled to any frame, whereby load of membrane filtration apparatus(es) can be uniformly distributed to all free-rollers during the filtration operation. Consequently, it is possible to (i) prevent damage to parts (particularly, the roller) which otherwise might be caused due to the biased load, thereby dramatically reducing operation and maintenance costs, and (ii) inhibit noise generation during the filtration operation.

What is claimed is:

1. A water treatment system comprising:
a biological treatment unit for biological treatment of wastewater; and
a membrane unit for filtration of the wastewater treated by the biological treatment unit,
wherein at least one selected from a group consisting of the biological treatment unit and the membrane unit comprises a plurality of quorum quenching media confined in a predetermined space therein.

2. The water treatment system according to claim 1, wherein the plurality of quorum quenching media is confined in the predetermined space by means of a mesh-shaped container.

3. The water treatment system according to claim 1, wherein each of the quorum quenching media comprises:
a carrier; and
quorum quenching microbes on the carrier.

4. The water treatment system according to claim 3, wherein the carrier is a hydrogel of a three-dimensional reticulated structure comprising at least one selected from a group consisting of alginate, polyvinyl alcohol, polyethylene glycol, and polyurethane.

5. The water treatment system according to claim 1, wherein the membrane unit comprises:
a tank into which the wastewater treated by the biological treatment unit is introduced; and
at least one membrane filtration apparatus configured to perform filtration in a state in which at least a part of the membrane filtration apparatus is submerged in the wastewater introduced into the tank.

6. The water treatment system according to claim 5, wherein
the membrane unit further comprises a mesh-shaped container mounted on the tank such that at least a part of the mesh-shaped container is submerged in the wastewater,
at least a portion of the quorum quenching media are disposed in the mesh-shaped container, and
the quorum quenching media have a particle size greater than a pore size of the mesh-shaped container.

7. The water treatment system according to claim 5, wherein
the membrane filtration apparatus comprises:
a skid frame;
a plurality of membrane modules installed in the skid frame; and
at least one quorum quenching module installed in the skid frame,
the quorum quenching module comprises:
upper and lower headers detachably coupled to the skid frame; and
a mesh-shaped container disposed between the upper and lower headers, both ends of the mesh-shaped container being coupled to the upper and lower headers, respectively,
at least a portion of the quorum quenching media are disposed in the mesh-shaped container, and
the quorum quenching media have a particle size greater than a pore size of the mesh-shaped container.

8. The water treatment system according to claim 5, wherein the membrane unit further comprises a driving unit for reciprocating motion of the membrane filtration apparatus.

9. The water treatment system according to claim 8, wherein the membrane unit further comprises:
a first rail configured to reciprocate together with the membrane filtration apparatus;
a second rail configured to guide the reciprocating motion of the membrane filtration apparatus; and
a free-roller located between the first and second rails, the free-roller being movable relative to both the first and second rails.

10. The water treatment system according to claim 9, wherein
the membrane unit comprises a plurality of the membrane filtration apparatuses,
the membrane unit further comprises a reciprocating frame to which the plurality of membrane filtration apparatuses are individually coupled,
the driving unit is configured to implement the reciprocating motion of the membrane filtration apparatuses through the reciprocating frame,
the reciprocating frame has a bottom surface that faces the free-roller, and
the first rail is mounted on the bottom surface of the reciprocating frame.

11. The water treatment system according to claim 10, wherein the first rail is elastically mounted on the bottom surface of the reciprocating frame such that a distance between the first rail and the reciprocating frame is variable.

12. The water treatment system according to claim 10, wherein
the membrane unit further comprises a guide frame provided on a top of the tank,
the guide frame has a top surface that faces the free-roller, and
the second rail is mounted on the top surface of the guide frame.

13. The water treatment system according to claim 12, wherein
the membrane unit further comprises a pivot member having a central hole,
a first end of the pivot member is pivotably coupled to the guide frame,
a second end of the pivot member is a two-pronged end having first and second fingers,
a rotating shaft connected to a rotation axis of the free-roller extends through the central hole of the pivot member, and
a protrusion provided at the reciprocating frame is disposed in a gap between the first and second fingers.

14. The water treatment system according to claim 9, wherein
the membrane unit comprises a plurality of the membrane filtration apparatuses,
each of the membrane filtration apparatuses comprises:
a skid frame; and
a plurality of membrane modules installed in the skid frame,
the skid frame comprises:
a supporting frame;
a lower horizontal frame;
an upper horizontal frame located between the supporting frame and the lower horizontal frame; and
a plurality of vertical members configured to connect the supporting frame, the upper horizontal frame, and the lower horizontal frame to each other,
the supporting frame has a bottom surface that faces the free-roller, and
the first rail is mounted on the bottom surface of the supporting frame.

15. The water treatment system according to claim 14, wherein the first rail is elastically mounted on the bottom surface of the supporting frame such that a distance between the first rail and the supporting frame is variable.

16. The water treatment system according to claim 14, wherein
the membrane unit further comprises a guide frame provided on a top of the tank,
the guide frame has a top surface that faces the free-roller, and
the second rail is mounted on the top surface of the guide frame.

17. The water treatment system according to claim 16, wherein
the membrane unit further comprises a pivot member having a central hole,
a first end of the pivot member is pivotably coupled to the guide frame,
a second end of the pivot member is a two-pronged end having first and second fingers,
a rotating shaft connected to a rotation axis of the free-roller extends through the central hole of the pivot member, and
a protrusion provided at the supporting frame is disposed in a gap between the first and second fingers.

18. The water treatment system according to claim 14, wherein
the supporting frames of the plurality of membrane filtration apparatuses are detachably coupled to each other, and
each of the membrane filtration apparatuses further comprises a lifting hook receiver provided on the supporting frame.

19. The water treatment system according to claim 1, wherein the biological treatment unit comprises at least one selected from a group consisting of an anoxic tank, an anaerobic tank, and an aerobic tank.

20. The water treatment system according to claim 19, wherein
the biological treatment unit comprises the aerobic tank, and
at least a portion of the quorum quenching media are confined in a predetermined space of at least one selected from the group consisting of the anoxic tank, the anaerobic tank, and the aerobic tank.
